(19) United States
(12) Patent Application Publication
(10) Pub. No.: US 2006/0183458 A1
(43) Pub. Date: Aug. 17, 2006

(54) Color matching process for field repair of vehicle coatings

(76) Inventor: Keith A. Sena, Canton, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/353,914

(22) Filed: Feb. 14, 2006

Related U.S. Application Data
(60) Provisional application No. 60/653,754, filed on Feb. 17, 2005.

(51) Int. Cl. B05D 3/00; B05D 1/36; H04Q 7/20

(52) U.S. Cl. 455/403; 427/140; 427/421.1; 427/402

(57) ABSTRACT

This invention is directed to a computer-implemented process for the repair of at least one blemish in a paint coating of vehicle which comprises the following steps: (1) the a manufacturer of the vehicle is selected from a list stored in a personal digital assistant (PDA); (2) the paint code of the vehicle is entered into the PDA from the vehicle identification number on the vehicle; (3) paint formulas and any variant paint formulas based on the paint code from a central color data base in a remote central computer are downloaded from a memory card or similar device into the PDA; (4) a matching paint formula or a variant thereof is obtained from the PDA that shows all ingredients for the matching paint formula; and (5) the ingredients are mixed to form a paint that is applied to the blemish using paint application techniques to color match the vehicle paint coating and the paint is dried and cured.

### CROSS-REFERENCE TO RELATED APPLICATIONS

This application claims priority under 35 U.S.C. § 1219 from U.S. Provisional Application Ser. No. 60/653,754, filed Feb. 17, 2005.

### BACKGROUND OF THE INVENTION

This invention relates to a portable computer-implemented method for the repair of vehicles, such as, automobiles and trucks in the field, i.e., outside of a refinish repair facility, using information stored in a PDA (personal digital assistant) to provide a matching paint formula and the paint can be mixed and applied in the field using standard techniques to repair and color match the finish on a vehicle.

If a vehicle is involved in a collision or the paint finish on a vehicle becomes damaged, for example, by vandalism and major refinishing of the vehicle is required, this typically is done in a commercial refinish facility that has all of the commercial spray equipment, spray booths, ovens, paint mixing equipment, paint color matching equipment that facilitates such a repair. For the vehicle owner to use such a facility often is a major inconvenience, since the vehicle generally must be left at the facility for several days to complete the repair and refinish. For small scratches nicks or dents or flaws in the finish of a vehicle that are often caused by mechanical action but may also be caused by chemical action or by atmospheric conditions, e.g., hail or acid rain but only require a very small or minor refinish repair, it would be very desirable to have a portable service available in the field that could come to the vehicle owners home or work place and make the repair in a short period of time without having the vehicle in a repair facility for several days. Attempts have been made to accomplish this but have been found to be time consuming and required direct links to vehicle and paint manufacturers data bases.

U.S. Pat. No. 6,522,977 shows a computer implemented method for matching a paint color that involves the used of a main frame computer of a paint manufacturer. WO 2004/018984 is directed to matching colors of various objects, for example, matching the color of various home furnishings. U.S. 2004/0093112A1 published May 13, 2004 shows a paint color selection method using reference paint chips. None of the above are directed to a portable color matching process for refinishing vehicles in the field.

The novel process of this invention provides a computer implemented color matching process for the repair of vehicle coatings.

### SUMMARY OF THE INVENTION

This invention is directed to a computer-implemented process for the repair of at least one blemish in a paint coating of a vehicle which comprises the following steps:
(1) selecting a manufacturer of the vehicle from a list of manufacturers stored in the memory of a personal digital assistant (PDA);
(2) entering paint code information from the vehicle identification number (VIN) on the vehicle into the PDA;
(3) down-loading paint formulas and any variant paint formulas from a memory card into the memory of the PDA based on the paint code, wherein the paint formulas on the memory card are obtained from a central color data base in a remote central computer of a paint manufacturer;
(4) obtaining a matching paint formula or a variant thereof from the memory of the PDA and selecting the matching paint formula showing all ingredients for the paint formula; and
(5) mixing the ingredients to form a paint and applying the paint to the blemish in the vehicle paint coating using color matching paint application techniques to color match the repair of the blemished paint coating to the vehicle paint coating of the vehicle and allowing the paint to dry and cure.

### BRIEF DESCRIPTION OF THE FIGURE

FIGS. 1A and 1B show an overall process flow chart of a computer implemented process to match the color of a vehicle paint coating.

### DETAILED DESCRIPTION OF THE INVENTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

As used herein “vehicle” includes an automobile; truck; semitruck; tractor; motorcycle; trailer; ATV (all terrain vehicle); pickup truck; heavy duty mover, such as, bulldozer, mobile crane and earth mover; airplanes; boats; ships; and other modes of transport that are coated with coating compositions.

A typical vehicle body (auto or truck) or part thereof is produced from a steel sheet or a plastic or a composite substrate. For example, the fenders may be of plastic or a composite and the main portion of the body of steel. If steel is used, it is first treated in a bath, typically a phosphate bath that contains an inorganic rust-proofing compound, such as, zinc or iron phosphate and then a primer coating is applied generally by E-Coat (electrodeposition) by passing the vehicle body through an electrocoating tank. Typically, these primers are epoxy-modified resins cross linked with a polyisocyanate and are applied by a cathodic electrodeposition process and baked in an oven. The vehicle body is then passed through top coating system that applies a primer coating, a base coating that contains pigment to provide color to the resulting finished paint and a clear coating is applied and provides a glossy in depth appearance to the finish on the automobile or truck body and the finish has good gloss and distinctness of image. Also, the clear finish also provides a protective finish that is durable and resistant to scratching, marring and chipping and also provides resistance to weathering, in particular, to U.V. degradation and photo-oxidation.

Simple, low cost and convenient repairs of small blemishes or defects in the finish of vehicles, such as, scratches, for example, caused by the use of keys, abrasions, mars, cuts, small dents and similar blemishes or defects without requiring the vehicle to be in a repair facility for at least a day, has been a problem since conventional repair or refinish systems are not adaptable to such low cost convenient repairs. The advantage of the novel repair process of this invention is that it is simple, low cost, convenient and is portable and can be done in the field without tying up the vehicle at a refinish facility or have the owner spend time dropping off and picking up the vehicle at a repair facility.

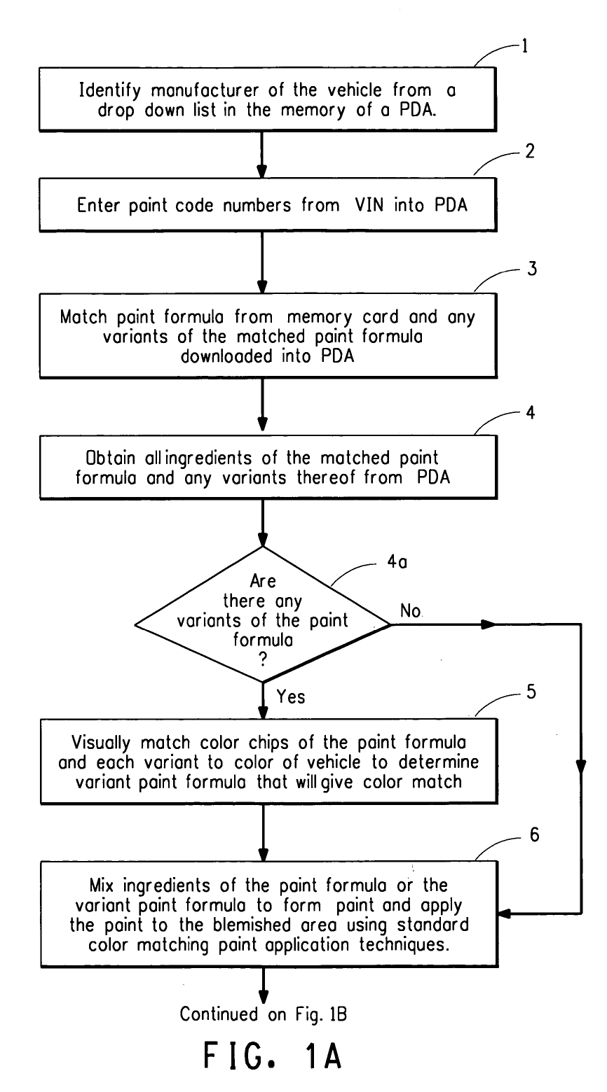

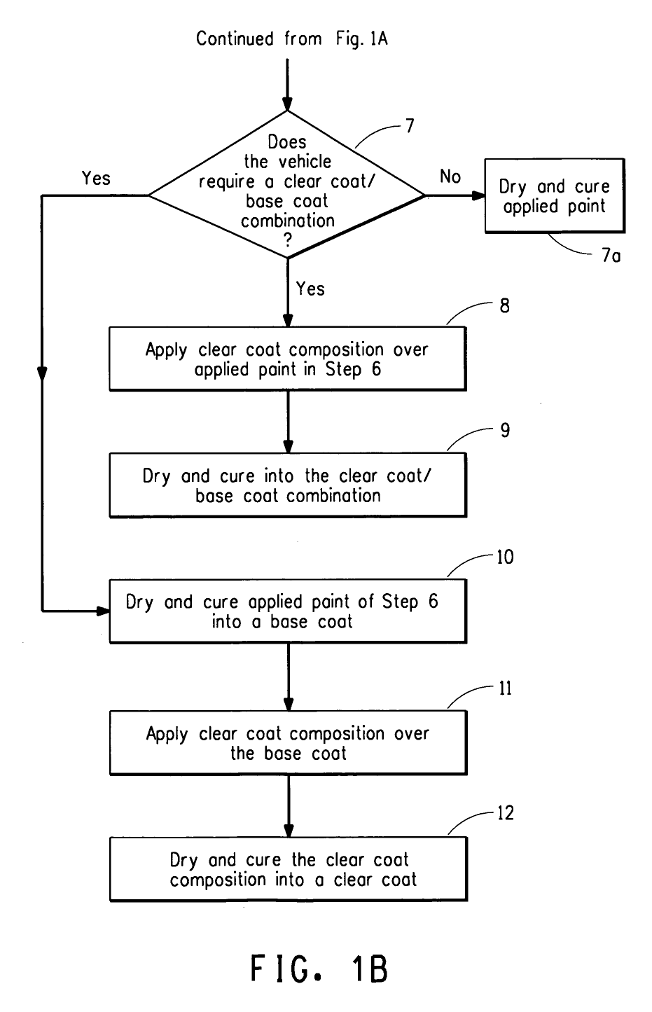

FIGS. 1A and B show a process flow chart of the computer implemented coating system of this invention. The process is directed to a field repair of a blemish in the paint finish of a vehicle. In the first step (1), the operator identifies the manufacturer of the vehicle from a drop down list that is in the memory of the PDA being used. A paint code obtained from the VIN (usually, the last three number or character of the VIN) is entered into the PDA in the second step (2).

In step (3), paint formulas and any variants corresponding to the paint code thereof are down loaded into the memory of the PDA using a memory card or an equivalent, such as, a floppy disc or flash drive, such as, a Jump Drive 2.0 Pro by Lexar, Inc. memory stick, from the paint manufacturer that contains paint formulas for various colors and paint formulas for any variant of any of these colors. A matching paint formula or a variant of the matching paint formula is selected.

One particularly useful PDA that can be used in the process of this invention is a Palm Zire 31, manufactured by PalmOne, Inc. located Milpitas, Calif., USA.

A “variant” is a deviation from the standard or official paint color. A variant occurs when slight differences in settings, conditions and manufacturing procedures occur in the manufacture of a paint or in the application of paint to vehicles. Such variants are determined by monitoring paint manufacturing plants or auditing vehicles in the market place, such as, ports of entry, rail heads and other convenient locations that handle a large number and wide variety of various vehicle makes, models and colors. If, in the monitoring procedure, it is determined that there is a significant deviation from the standard color that can not be matched by standard spray application procedures, a variant paint formula then is created that can be matched to the paint on the vehicle.

Returning to FIG. 1, the ingredients of the paint formula are obtained from the PDA in step (4) and in step (4a) it is determined if there are variants for the matching paint formula and if the answer is NO, the operator proceeds from step (4) to step (6) and mixes the ingredients of the paint according to the matching paint formula of step (4). By using standard color matching spray application techniques in step (6), the operator spray applies the paint to the blemished or damaged paint area of the vehicle. In step (7) it is determined if the repair is a clear coat/base coat combination finish and if NO, the applied paint is allow to dry and is cured in step (7a).

If the finish on the vehicle is a clear coat/base coat combination finish, after application of the colored or pigmented basecoat in step (6) a clear coat is applied generally by spray application in step (8). The clear coat can be applied while the basecoat is still wet, for example, after a short flash time, e.g., 0-30 seconds to allow for evaporation of solvent (wet on wet process) or allow the basecoat to be dry to the touch. In step (9), the clear coat/base coat combination finish is dried and cured.

Alternatively, if it is determined in step (7) that the finish is a clear coat/base coat combination finish and that complete drying of the basecoat is desired, the base coat applied in step (6) is dried and cured in step (10) and then the clear coat is applied over the base coat in step (11) and the clear coat is dried and cured in step (12) to form the base coat/clear coat combination finish.

If it is determined in step (4a) that there are variants for the matching paint formula in step (5), color matching of the variant to the color of the vehicle is required. This is accomplished visually by matching a color chip of the variant to the color of the finish being repaired. A color chip is a substrate coated with a dried and cured layer of the paint composition of the variant. In matching the color of the paint of the vehicle, the color chip is placed on or next to the surface portion of the vehicle that is being repair and by visual examination and comparison, a color match is determined by the operator. If a color match can not be achieved, the operator can contact the paint manufacturer to determine if additional variant paint formulas are available to match the paint of the vehicle being repaired. If there are additional variant formulas available from the paint manufacturer, these can be transmitted to the operator and downloaded into the PDA and step (5) is repeated. Steps (6) through (11) are reiterated as described above for the application of the matching variant paint formula.

The matching paint formula provided by the PDA can be sized to the amount needed for the repair of the blemish by providing information to the PDA on the size of the area to be repaired. The software provided calculates the paint volume to 1/100th of a typical collision repair formula as the starting point. Typically, a typical collision repair formula is for 1 liter. Depending on the area to be repaired, the operator can increase the amount of paint to be mixed in small increments to meet needs for the particular repair.

The present invention is further defined in the following Example. It should be understood that this Example is given by way of illustration only. From the above discussion and this Example, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

### EXAMPLE

A PDA, a Palm Zire 31, described above, using programming language C++ and a Metrowerks CodeWarrior 9.0 IDE to compile the application data from a source is used. The operator loads the software application into the PDA hard drive via a memory card and installs a shortcut icon on the desktop of the PDA. The software application is activated by selecting the shortcut icon on the PDA desktop. The operator can then proceed to make the following repair.

The vehicle to be repaired is a blue 2002 Ford Escort that has a small key scratch on the driver's door. The operator starts by identifying the vehicle paint code from the Vehicle Identification Plate having the VIN inscribed thereon. The plate is located on the driver side door or door frame. The VIN on the Vehicle Identification Plate indicates a paint code “CX.” This information is entered into the PDA either through a keyboard on the screen of the PDA, or via the PDA's graffiti pad. To narrow the range of formulas available, the vehicle manufacturer is selected. The operator selects “Ford” and uses the graffiti pad to write “CX” with a stylus. The operator clicks the “Next” icon to search for the paint formula.

The paint formula for vehicle, the year and paint code are displayed on the PDA screen. Variant paint formulas are available for this particular color and the operator selects the best match from a variant deck of color chips provided by the paint manufacturer for that particular color by using visual color documentation to determine that, of the three variations on the color presented (Standard, Lighter, Less Light), the “Standard” color is in fact, appropriate.

The operator then enters his Mix Quantity, or the amount of paint that is needed. The operator makes a judgment on the quantity of paint required for a particular repair. In this situation, a pint of paint was formulated. The PDA's software calculates the weight of the various constituents required to formulate the paint and displays the following toner colors and weights, e.g., for a US pint, to mix to form the repair paint:

| Toner Colorants | Parts by Weight |
|---|---|
| Toner 571 (brownish black) | 15.92 |
| Toner 811 (silver dollar, course) | 33.21 |
| Toner 885 (lapis blue) | 37.14 |
| Toner 593 (coarse silver) | 41.19 |
| Toner 008 (metallic additive) | 44.54 |
| Toner 570 (white) | 44.65 |

The above toners used are toners of a commercial Standox® Mixing Machine available from E.I. du Pont de Nemours and Company, Wilmington, Del., USA.

The on-going total weight of the mixture is also displayed at each stage of mixing. The operator mixes the appropriate toners and volumes into a mixing cup and transfers it to a spray gun.

The repair process follows “conventional” body shop practices wherein there is some surface preparation of the scratch required and the scratch is filled with a putty and the surrounding paint area masked and the area is lightly sanded. The operator then sprays the paint onto the area to be repaired using conventional spray color matching techniques. The amount of paint used to effect the repair is about 1/100th the volume of paint required for a typical body shop repair of similar damage. The paint is allowed to dry for about 5 minutes and cures in about 10 minutes. A clear coat was then applied only to the repair area and the area was slightly buffed resulting in an un-noticeable paint repair.

In such a typical “micro-repair” condition, environmental regulations state that the volume of material sprayed is within the “conditionally exempt generator” range, or amounts below where special equipment is required (for example, enclosed spray-booth with air movement). As a result, such repairs can be completed, for example, on a car dealership's lot.

What is claimed is:

1. A computer-implemented process for the repair of at least one blemish in a paint coating of a vehicle which comprises
(1) selecting a manufacturer of the vehicle from a list of manufacturers stored in the memory of a personal digital assistant (PDA);
(2) entering a paint code into the PDA of the vehicle from the vehicle identification number on the vehicle;
(3) down-loading paint formula and any variant paint formulas wherein such formulas are available from a memory card into the PDA based on the paint code, wherein the paint formulas on the memory card are obtained from a central color data base in a remote central computer of a paint manufacturer;
(4) obtaining matching paint formula or variant paint formula from the memory of the PDA selecting the matching paint formula showing all ingredients showing all ingredients for the paint formula; and
(5) mixing the ingredients to form a paint and applying the paint to the blemish in the paint coating of the vehicle using color matching paint application techniques to color match the repair of the blemished paint coating to the paint coating of the vehicle and allowing the paint to dry and cure.

2. The computer implemented process of claim 1 wherein there are variant paint formulas available, visually, color matching paint of each variant paint formula to the coating of the vehicle having a blemish that is being repaired and obtaining the matching variant paint formula from the PDA.

3. The computer implemented process of claim 1 wherein the paint formula is sized according to the size of the repair.

4. The computer implemented process of claim 1 being tied via computer to the paint manufacturer for determination of different variants not in the paint formulas down loaded into the PDA.

5. The computer implemented process of claim 1 wherein spray color matching techniques are used to match the color of the vehicle paint coating.

6. The computer implemented process of claim 5 wherein a color coat is matched to the color of the paint coating and subsequently before or after drying of the color coat, a clear coating is applied.

7. The computer implemented process of claim 1 in which the process is a portable process for field repair of blemished coatings of vehicles.

8. A personal digital assistant having a memory component and containing software capable of storing paint formulas and variants thereof for the paint colors of vehicle manufactures and capable of providing a paint formula matching a vehicle.
